(19) United States
(12) Patent Application Publication
(10) Pub. No.: US 2025/0060967 A1
(43) Pub. Date: Feb. 20, 2025

(54) NETWORK DEVICE, SYSTEM, AND METHOD OF OPERATING CXL SWITCHING DEVICE FOR SYNCHRONIZING DATA

(71) Applicant: Samsung Electronics Co., Ltd., Suwon-si (KR)

(72) Inventors: Younghyun LEE, Suwon-si (KR); Jinin SO, Suwon-si (KR); Kyungsoo KIM, Suwon-si (KR); Sangsu PARK, Suwon-si (KR); Jin JUNG, Suwon-si (KR); Jeonghyeon CHO, Suwon-si (KR)

(73) Assignee: Samsung Electronics Co., Ltd., Suwon-si (KR)

(21) Appl. No.: 18/642,977

(22) Filed: Apr. 23, 2024

(30) Foreign Application Priority Data
Aug. 18, 2023 (KR) 10-2023-0108259

(51) Int. Cl. G06F 9/30; G06F 9/48; G06F 17/16

(52) U.S. Cl. CPC G06F 9/3836; G06F 9/30036; G06F 17/16

(57) ABSTRACT

Various example embodiments may include methods of operating a network device, non-transitory computer readable media including computer readable instructions for operating a network device, systems including a network device, and/or a compute express link (CXL) switching device for synchronizing data. A CXL-based system includes a plurality of CXL processing devices configured to perform matrix multiplication calculation based on input vector data and a partial matrix, and output at least one interrupt signal and at least one packet based on results of the matrix multiplication calculation, the at least one packet including output vector data and characteristic data associated with the output vector data, and a CXL switching device configured to, synchronize the output vector data, the synchronizing including performing a calculation operation on the output vector data based on the interrupt signal and the packet, and provide the synchronized vector data to the plurality of CXL processing devices.

### CROSS-REFERENCE TO RELATED APPLICATIONS

This U.S. non-provisional application is based on and claims the benefit of priority under 35 U.S.C. § 119 to Korean Patent Application No. 10-2023-0108259, filed on Aug. 18, 2023, in the Korean Intellectual Property Office, the disclosure of which is incorporated by reference herein in its entirety.

### BACKGROUND

Various example embodiments of the inventive concepts relates to an electronic device, and more particularly, to a network device, a system, a non-transitory computer readable medium, and/or a method of operating a compute express link (CXL) switching device, for synchronizing data.

As technologies such as artificial intelligence (AI), big data, and edge computing develop, there is a growing need to quickly process large amounts of data on devices. High-bandwidth applications that perform complex computations desire and/or require faster data processing and/or more efficient memory access. For example, in very large artificial intelligence models, such as a Large-Language Model (LLM), large amounts of parameters are processed for interfacing. For this purpose, technology is being developed in which weight matrices are divided and stored in processing devices, such as multiple GPUs and/or FPGA devices, and each device processes data in parallel. At this time, since data and/or results are calculated separately in each device based on partial information, results and/or data based on overall information is needed, and therefore a data synchronization process for overall results and/or data is desired and/or necessary. Generally, in the case of a synchronization process, partial data calculated by each device is transmitted to a central device (and/or a desired device), and the central device synchronizes the partial data based on overall information and re-transmits the synchronized data to each device. However, this synchronization process may cause bottlenecks and/or congestion between devices, thereby increasing computation latency.

### SUMMARY

According to at least one example embodiment of the inventive concepts, there is provided a compute express link (CXL)-based system including a plurality of CXL processing devices configured to perform matrix multiplication calculation based on input vector data and a partial matrix, and output at least one interrupt signal and at least one packet based on results of the matrix multiplication calculation, the at least one packet including output vector data and characteristic data associated with the output vector data, and a CXL switching device configured to synchronize the output vector data, the synchronizing including performing a calculation operation on the output vector data based on the interrupt signal and the packet, and provide the synchronized vector data to the plurality of CXL processing devices.

According to at least one example embodiment of the inventive concepts, there is provided a method of operating a compute express link (CXL) switching device, the method including receiving a plurality of packets and at least one interrupt signal from a plurality of CXL processing devices, wherein each of the plurality of packets includes vector data and characteristic data associated with the vector data, synchronizing the vector data, the synchronizing including performing a calculation operation on the vector data based on the plurality of packets and the interrupt signal, and outputting the synchronized vector data to the plurality of CXL processing devices.

According to at least one example embodiment of the inventive concepts, there is provided a compute express link (CXL)-based network device including memory configured to store vector data of a plurality of packets received from a plurality of processing devices, and processing circuitry configured to, store at least one instruction signal in the memory based on characteristic data of the plurality of packets in response to a plurality of interrupt signals received from the plurality of processing devices, determine a calculation operation type based on at least one instruction signal stored in the memory, synchronize vector data stored in the memory, the synchronizing including performing the calculation operation on the vector data based on the determined calculation operation type, and output the synchronized vector data.

### BRIEF DESCRIPTION OF THE DRAWINGS

Various example embodiments of the inventive concepts will be more clearly understood from the following detailed description taken in conjunction with the accompanying drawings in which:

FIG. 1 is a block diagram showing a system according to at least one example embodiment;

FIGS. 2A, 2B, and 2C are diagrams for describing the operation of a system according to at least one example embodiment;

FIG. 3 is a block diagram showing a control logic according to at least one example embodiment;

FIG. 4 is a block diagram showing a memory according to at least one example embodiment;

FIG. 5 is a block diagram showing a compute logic according to at least one example embodiment;

FIG. 6 is a block diagram showing a CXL processing device according to at least one example embodiment;

FIGS. 7A and 7B are diagrams for describing data flows according to a comparative example and at least one example embodiment;

FIG. 8 is a flowchart of a method of operating a system according to at least one example embodiment;

FIG. 9 is a flowchart for describing at least one example embodiment of operation S20 of FIG. 8;

FIG. 10 is a flowchart for describing at least one example embodiment of operation S220 of FIG. 9; and

FIG. 11 is a flowchart for describing at least one example embodiment of operation S230 of FIG. 9.

### DETAILED DESCRIPTION

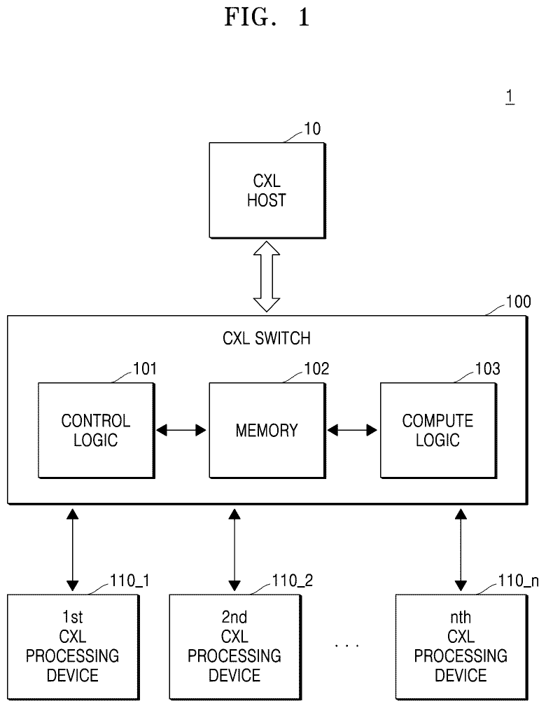

FIG. 1 is a block diagram showing a system according to at least one example embodiment.

Referring to FIG. 1, a system 1 may support compute express link (CXL) protocols, but is not limited thereto. A CXL may serve as a counterpart to other protocols, such as Non-Volatile Memory express over fabric (NVMeoF), etc., that may be used for configurability (e.g., configuration) of at least one remote input/output (I/O) device. As used herein, the term “composable” may refer to a property of a given device (e.g., a cache coherence-enabled device in a particular cluster, etc.) capable of requesting and/or obtaining resources (e.g., memory, computing, and/or network resources, etc.) from another part of a network (e.g., at least another cache coherence-enabled device in a second cluster, etc.) to execute at least a part of a workload (e.g., computer processing, mathematical processing, neural network processing, LLM processing, AI processing, etc.). According to some example embodiments, the term “composability” may include the use of a flexible pool of physical and virtual computing, storage, and/or fabric, etc., resources in any suitable configuration to run any application and/or workload. The CXL is an open industry standard for communications based on the Peripheral Component Interconnect Express (PCIe) 5.0 protocol, which may provide fixed, relatively short packet sizes, thereby providing a relatively high bandwidth and/or a relatively low fixed latency. As such, the CXL may support cache coherence, and the CXL may be well suited for creating connections to a memory (e.g., at least one memory device, etc.). The CXL may also be used by at least one server to provide connections between at least one host (e.g., at least one host device, etc.) and an accelerator, memory devices, and/or network interface circuits, (e.g., “network interface controllers” and/or network interface cards (NICs), etc.). Cache coherence protocols such as CXL may be employed for heterogeneous processing, for example, in scalar, vector, and/or buffered memory systems, but is not limited thereto. The CXL may be used to provide a cache-coherent interface by utilizing channels, retimers, PHY layers of a system, logical aspects of an interface, and/or protocols from the PCIe 5.0 protocol. A CXL transaction layer may include three multiplexed sub-protocols operating simultaneously on a single link and may be referred to as CXL.io, CXL.cache, and CXL.memory. CXL.io may include I/O semantics that may be similar to PCIe. CXL.cache may include caching semantics, CXL.memory may include memory semantics, and both the caching semantics and the memory semantics may be optional. Similar to PCIe, CXL supports: (i) divisible native widths of x16, x8, and x4, (ii) data rates of 8 GT/s, 16 GT/s, and 32 GT/s degradable to 128b/130b, (iii) 300 W (e.g., an x16 connector may support 75 W), and (iv) plug and play. To support plug and play, a PCIe and/or CXL device link may start training a Gen1 PCIe, negotiate a CXL, and initiate a CXL transaction after completing Gen 1-5 training, etc.

The system 1 may include a CXL host 10 (e.g., a CXL host device, etc.), a CXL switch 100, and/or first to nth CXL processing devices 110_1, 110_2, . . . , and 110_n, but the example embodiments are not limited thereto, and for example, the system 1 may include a greater or lesser number of constituent devices. n may be an integer equal to or greater than 2.

The CXL host 10 may process data using processing circuitry, e.g., a central processing unit (CPU), an application processor (AP), and/or a system-on-a-chip (SoC), etc. The CXL host 10 may execute an operating system (OS) and/or various applications (e.g., software applications, etc.). The CXL host 10 may be connected to a host memory. The CXL host 10 may include a physical layer, a multi-protocol multiplexer, interface circuits, a coherence/cache circuit, a bus circuit, at least one core (e.g., processor core, etc.), and/or at least one input/output device, etc., but is not limited thereto, and for example, may include a greater or lesser number of constituent elements. The CXL host 10 is connected through at least one CXL interface to the first to nth CXL processing devices 110_1, 110_2, . . . , and 110_n and may generally control the operation of the first to nth CXL processing devices 110_1, 110_2, . . . , and 110_n. The CXL interface is an interface capable of reducing the overhead and waiting time of a host device and a semiconductor device and allowing sharing of spaces of a host memory and a device memory in a heterogeneous computing environment in which the CXL host 10 and the first to nth CXL processing devices 110_1, 110_2, . . . , and 110_n operate together due to rapid innovation of special workloads such as data compression and encryption and artificial intelligence (AI). The CXL host 10 and the first to nth CXL processing devices 110_1, 110_2, . . . , and 110_n may maintain and/or improve memory consistency at a high bandwidth and/or a very high bandwidth through the CXL interface. The CXL interface includes at least three subprotocols, e.g., CXL.io, CXL.cache, and CXL.mem. For example, CXL.io uses a PCIe interface and is used to search for devices in the system, manage interruptions, provide accesses by registers, handle initialization, and/or handle signal errors, etc. CXL.cache may be used when a computing device, such as an accelerator included in a semiconductor device, etc., accesses a host memory of a host device, etc. CXL.mem may be used by the host device to access a device memory included in a semiconductor device, etc.

The CXL switch 100 may synchronize output vector data by performing calculations on the output vector data based on interrupt signals and/or packets (e.g., data packets, etc.). The CXL switch 100 may provide synchronized vector data to the first to nth CXL processing devices 110_1, 110_2, . . . , and 110_n. The CXL switch 100 according to at least one example embodiment of the inventive concepts may be referred to as a CXL switching device and/or a CXL-based network device, etc. The use of CXL connections to at least one memory pool may provide a variety of advantages and/or technical benefits in a system including, for example, a plurality of servers connected to one another through a network, but the example embodiments are not limited thereto. For example, the CXL switch 100 may have additional functions other than providing packet-switching functionality for CXL packets. The CXL switch 100 may be used to connect a memory pool to one or more CXL hosts 10 and/or one or more network interface circuits. According to this, (i) a memory set may include various types of memories with different characteristics, (ii) the CXL switch 100 may virtualize the memory set and enable storage of data of different characteristics (e.g., access frequencies, etc.) in a memory of a suitable type, and/or (iii) the CXL switch 100 may support a remote direct memory access (RDMA), such that an RDMA may be performed with little and/or no involvement by a processing circuit of a server, etc. The term “virtualizing memory” refers to performing memory address translation between a processing circuit and a memory, e.g., translating a virtual memory address associated with a software application, such as an operating system, etc., into a physical address of the memory device(s). Additionally, the CXL switch 100 may (i) support isolation between a memory and an accelerator through single-level switching, (ii) support resources to be switched off-line and on-line between domains and enable time multiplexing across domains when requested, and/or (iii) support virtualization of downstream ports, etc. CXL may be used to implement a memory set that enables one-to-many switching and many-to-one switching when aggregated devices are divided into a plurality of logical devices each having a logical device identifier (LD-ID). For example, (i) CXL may connect a plurality of root ports to one endpoint, (ii) connect one root port to a plurality of endpoints, and/or (iii) connect a plurality of root ports to a plurality of endpoints, etc. According to some example embodiments, a physical device may be divided into a plurality of logical devices, each visible to an initiator. A device may have one physical function (PF) and a plurality of (e.g., 16, etc.) separate logical devices. According to some example embodiments, the number of logical devices (e.g., the number of partitions) may be limited (e.g., up to 16), and one control partition (which may be a PF used to control a device) may also exist, but the example embodiments are not limited thereto. The CXL switch 100 may include a number of input/output ports configured to be connected to a network and/or fabric. For example, each input/output port of the CXL switch 100 may support a CXL interface and implement a CXL protocol, but is not limited thereto.

According to some example embodiments, the CXL switch 100 may include a control logic 101, a memory 102, and/or a compute logic 103, but the example embodiments are not limited thereto. According to some example embodiments, one or more of the control logic 101, the memory 102, the compute logic 103, etc., may be implemented as processing circuitry. Processing circuitry may include hardware or hardware circuit including logic circuits; a hardware/software combination such as a processor executing software and/or firmware; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc., but is not limited thereto.

The control logic 101 may store at least one instruction signal in the memory 102 based on characteristic data in response to at least one interrupt signal. For example, the control logic 101 may store an instruction signal in a memory based on characteristic data of a plurality of packets in response to a plurality of interrupt signals received from the first to nth CXL processing devices 110_1, 110_2, . . . , and 110_n, but is not limited thereto.

The memory 102 may be implemented as a volatile memory, but is not limited thereto, and for example, may be implemented as non-volatile memory. The volatile memory may include, for example, static random access memory (SRAM) but is not limited thereto. In another example, the volatile memory may include dynamic random access memory (DRAM), mobile DRAM, double data rate synchronous dynamic random access memory (DDR SDRAM), low power DDR (LPDDR) SDRAM, graphic DDR (GDDR) SDRAM, Rambus dynamic random access memory (RDRAM), etc. The memory 102 may temporarily store output vector data provided from the first to nth CXL processing devices 110_1, 110_2, . . . , and 110_n. The memory 102 may temporarily store at least one instruction signal provided from the control logic 101. Also, the memory 102 may store vector data of a plurality of packets received from the first to nth CXL processing devices 110_1, 110_2, . . . , and 110_n.

The compute logic 103 may check a calculation operation based on at least one instruction signal stored in the memory 102. The compute logic 103 may synchronize vector data stored in the memory 102 by performing at least one calculation operation on the vector data. The compute logic 103 may generate synchronized vector data according to the calculation operation. The compute logic 103 may store synchronized vector data in the memory 102.

The first to nth CXL processing devices 110_1, 110_2, . . . , and 110_n may be connected below the CXL switch 100, and thereby the plurality of CXL processing devices 110_1, 110_2, . . . , and 110_n may be configured as a memory pool. Each of the first to nth CXL processing devices 110_1, 110_2, . . . , and 110_n may perform, for example, a matrix multiplication calculation of input vector data and a partial matrix, but the example embodiments are not limited thereto, and may instead perform other forms of mathematical calculations on input data. Each of the first to nth CXL processing devices 110_1, 110_2, . . . , and 110_n may output at least one packet and at least one interrupt signal to the CXL switch 100. A packet (e.g., data packet) may include output vector data and/or characteristic data, but the example embodiments are not limited thereto. A unit of data transmitted per clock cycle may be referred to as a packet. A packet (e.g., data packet, etc.) according to the CXL specification may also be referred to as a flow control unit (flit). A packet may include a protocol ID field, a plurality of slots, and/or a CRC field, etc., but is not limited thereto. The protocol ID may be information to identify a plurality of protocols supported by a link and/or connection (e.g., CXL). A slot may be a region in the packet containing at least one message. A message may include, for example, a valid field, an operation code opcode field, an address ADDR field, and/or a reserved RSVD field, etc., but is not limited thereto. The number of fields included in a message, sizes of the fields, and/or types of the fields may vary depending on protocols. Each of the fields included in a message may include at least one bit of data and/or information, etc. A valid field may contain 1 bit indicating that a message is a valid message or an invalid message and/or used to determine whether the message is a valid message or an invalid message, etc. The opcode field may include a plurality of bits that define an operation corresponding to a message. The ADDR field may include a plurality of bits representing an address (e.g., memory address, etc.) related to the opcode field. The RSVD field may be a region where additional information may be included. Therefore, information newly added to a message by a protocol may be included in the RSVD field. A CRC field may include one or more bits used for transmission error detection.

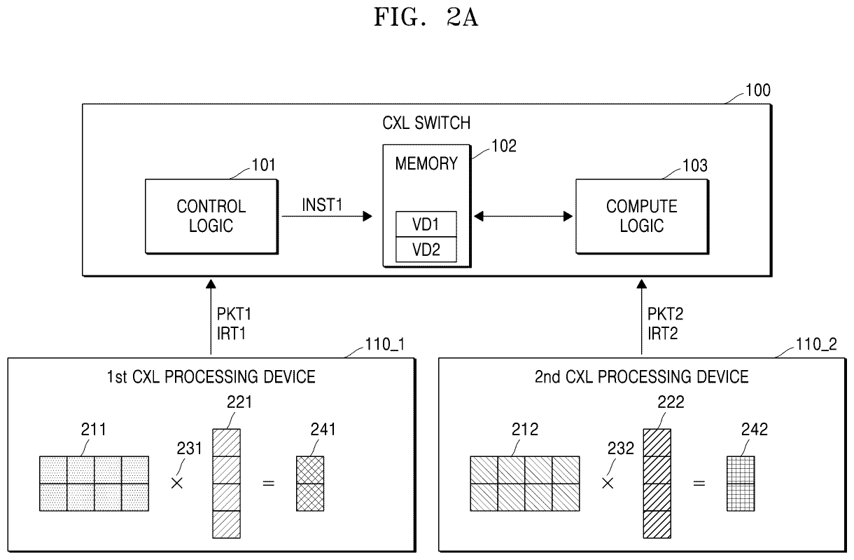

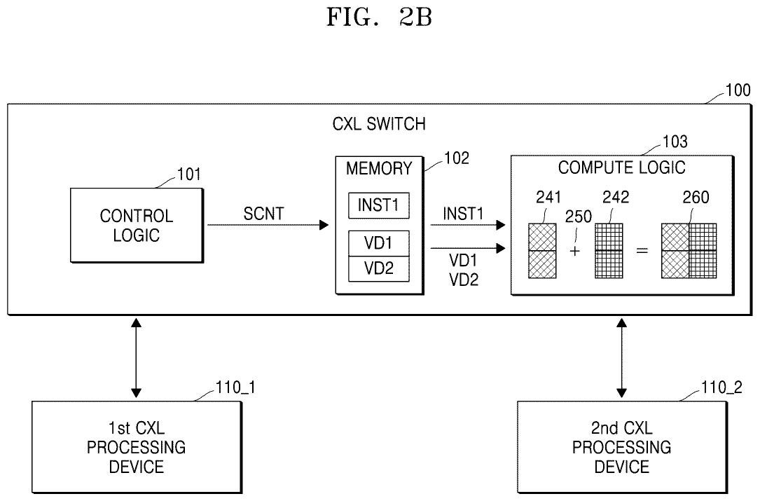

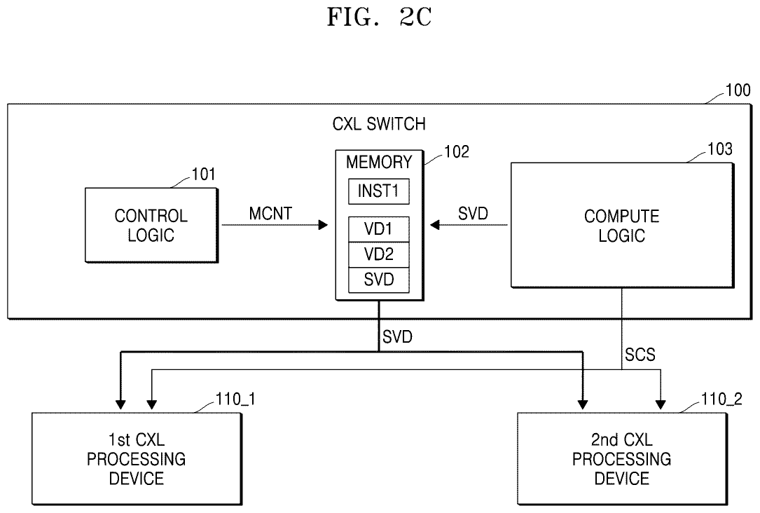

FIGS. 2A, 2B, and 2C are diagrams for describing the operation of a system according to at least one example embodiment. In FIGS. 2A, 2B, and 2C, for convenience of explanation, it is assumed that a plurality of CXL processing devices include a first CXL processing device 110_1 and a second CXL processing device 110_2, but the example embodiments are not limited thereto, and for example, there may be a greater number of CXL processing devices.

Referring to FIG. 2A, each of the plurality of CXL processing devices may store information regarding a partial matrix in advance, but are not limited thereto, and for example, the plurality of CXL processing devices may receive the partial matrix, etc. For example, the first CXL processing device 110_1 may store information regarding a first partial matrix 211, and the second CXL processing device 110_2 may store information regarding a second partial matrix 212. Information regarding a partial matrix may be stored in at least one register provided in each of the plurality of CXL processing devices. According to some example embodiments, a partial matrix stored in each of the plurality of CXL processing devices may correspond to a portion of a weight matrix of an AI model, but the example embodiment are not limited thereto. For example, the first partial matrix 211 and the second partial matrix 212 may be matrices divided by columns in a weight matrix of an AI model. However, the example embodiments of the inventive concepts are not limited thereto. The AI model may include, for example, various types of models including a large language model (LLM), such as GPT-3 and/or GPT-4, a convolution neural network (CNN), and/or a region proposal network (RPN), etc. According to another example embodiment, partial matrices stored in the plurality of CXL processing devices may be identical to each other. For example, the first partial matrix 211 and the second partial matrix 212 may be identical to each other.

Each of the plurality of CXL processing devices may perform an operation on the stored partial matrix and received input vector data, such as a matrix multiplication calculation of the partial matrix and input vector data, etc. but is not limited thereto. For example, the first CXL processing device 110_1 may perform a matrix multiplication calculation 231 of the first partial matrix 211 and first input vector data 221. The second CXL processing device 110_2 may perform a matrix multiplication calculation 232 of the second partial matrix 212 and second input vector data 222. Input vector data may be data containing vector values. Input vector data may be referred to as an embedding vector. When a partial matrix according to some example embodiments is a portion of a weight matrix of an AI model, the same input vector data may be input to each of the plurality of CXL processing devices, but the example embodiments are not limited thereto. For example, the first input vector data 221 and the second input vector data 222 may be identical to each other. According to other example embodiments, when partial matrices for the plurality of CXL processing devices are identical to each other, input vector data input to the plurality of CXL processing devices may be identical to or different from each other.

When a matrix multiplication calculation is performed in each of the plurality of CXL processing devices, output vector data may be generated by each of the plurality of CXL processing devices. Output vector data may be data containing vector values. For example, the first CXL processing device 110_1 may generate first output vector data 241, and the second CXL processing device 110_2 may generate second output vector data 242, etc.

Each of the plurality of CXL processing devices may transmit at least one packet and/or at least one interrupt signal to the CXL switch 100. According to some example embodiments, a packet may include output vector data and characteristic data, but is not limited thereto. The characteristic data may include information desired and/or necessary for synchronization in the CXL switch 100. Information desired and/or necessary for synchronization may include, for example, the type of a calculation, the length of an embedding vector (e.g., output vector data), the starting address of the embedding vector, information regarding each CXL processing unit (e.g., an ID, etc.), model information, etc. For example, the first CXL processing device 110_1 may provide a first packet PKT1 and a first interrupt signal IRT1 to the CXL switch 100, etc. The second CXL processing device 110_2 may provide a second packet PKT2 and a second interrupt signal IRT2 to the CXL switch 100, etc.

The CXL switch 100 may receive one or more packets and/or one or more interrupt signals from the plurality of CXL processing devices. Output vector data of packets may be stored in the memory 102. For example, first vector data VD1 and second vector data VD2 may be stored in the memory 102. The first vector data VD1 may correspond to the first output vector data 241, and the second vector data VD2 may correspond to the second output vector data 242, but the example embodiments are not limited thereto. The CXL switch 100 may generate at least one instruction signal based on characteristic data of a received packet in response to an interrupt signal. The instruction signal may include, for example, the address of the memory 102, the length of an embedding vector, the start address of the embedding vector, calculation information, model information, etc. For example, the control logic 101 may generate a first instruction signal INST1 based on first characteristic data of the first packet PKT1 and store the first instruction signal INST1 in the memory 102. For example, the control logic 101 may generate a second instruction signal based on second characteristic data of the second packet PKT2 and store the second instruction signal in the memory 102.

Referring to FIG. 2B, each of the plurality of CXL processing devices, e.g., the first CXL processing device 110_1 and the second CXL processing device 110_2, etc., may stand by until a synchronization completion signal is received from the CXL switch 100. The CXL switch 100 may perform at least one calculation on stored vector data based on at least one instruction signal. For example, the control logic 101 may output a scheduling control signal SCNT to the memory 102. The scheduling control signal SCNT may be a signal instructing the memory 102 to output the first instruction signal INST1 stored in the memory 102. The memory 102 may output the first instruction signal INST1 in response to the scheduling control signal SCNT. In addition, the control logic 101 may control and/or instruct the memory 102 to output the first vector data VD1 and the second vector data VD2 stored in the memory 102. The compute logic 103 may receive the first instruction signal INST1 from the memory 102 and the compute logic 103 may obtain the first vector data VD1 and the second vector data VD2 stored in the memory 102. The first vector data VD1 may correspond to the first output vector data 241, and the second vector data VD2 may correspond to the second output vector data 242, but are not limited thereto. The compute logic 103 may check a calculation operation 250 by decoding the first instruction signal INST1. For example, the calculation operation 250 may be a summation operation. However, the example embodiments of the inventive concepts are not limited thereto, and the calculation operation 250 may include one or more of various types such as an ADD operation, a MAX operation, etc. In FIG. 2B, it is assumed that the calculation operation 250 is a summation operation. The compute logic 103 may generate synchronized vector data SVD by calculating (e.g., summing) the first output vector data 241 and the second output vector data 242, but the example embodiments are not limited thereto.

Referring to FIG. 2C, the compute logic 103 may output and/or sequentially output a synchronization completion signal SCS and synchronized vector data SVD, but is not limited thereto. For example, the compute logic 103 may first output the synchronization completion signal SCS. The synchronization completion signal SCS may be transmitted to the first CXL processing device 110_1 and the second CXL processing device 110_2. The first CXL processing device 110_1 and the second CXL processing device 110_2 may confirm and/or determine that vector data is synchronized in response to the synchronization completion signal SCS. As soon as the calculation operation 250 is completed, the synchronized vector data SVD may be transmitted, e.g., transmitted in parallel, to each of the plurality of CXL processing devices, but is not limited thereto. For example, the compute logic 103 may store the synchronized vector data SVD in the memory 102. The control logic 101 may provide at least one memory control signal MCNT to the memory 102. The memory control signal MCNT may be a signal for controlling the memory 102 to output the synchronized vector data SVD, but is not limited thereto. The memory 102 may output the synchronized vector data SVD in response to the memory control signal MCNT. Each of the plurality of CXL processing devices may receive the synchronized vector data SVD and perform one or more additional calculations using the synchronized vector data SVD. According to some example embodiments, the first CXL processing device 110_1 and the second CXL processing device 110_2 may additionally perform calculations based on the synchronized vector data SVD. For example, the first CXL processing device 110_1 and the second CXL processing device 110_2 may generate a new embedding vector by calculating the average of rows of vector data, but is not limited thereto. The first CXL processing device 110_1 and the second CXL processing device 110_2 may transmit an index indicating a result value for a query provided by the CXL host 10 to the CXL host 10 through the CXL switch 100, but the example embodiments are not limited thereto. Also, the first CXL processing device 110_1 and the second CXL processing device 110_2 may transmit data indicating a matrix result value to the CXL host 10 through the CXL switch 100, etc.

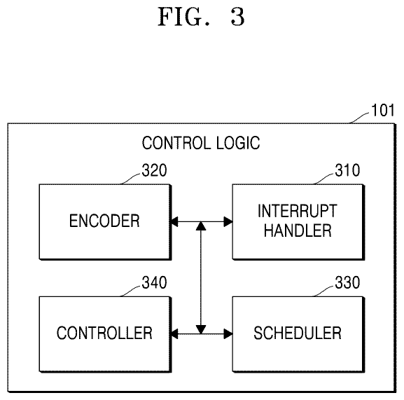

FIG. 3 is a block diagram showing a control logic according to at least one example embodiment.

Referring to FIG. 3, the control logic 101 may execute at least one interrupt routine in response to at least one interrupt signal. An interrupt routine may refer to a series of operations for encoding information desired and/or necessary for synchronization included in a packet into an instruction signal and storing the encoded instruction signal in an instruction queue. To this end, the control logic 101 may include an interrupt handler 310, an encoder 320, a scheduler 330, and/or a controller 340, but the example embodiments are not limited thereto. According to some example embodiments, one or more of the interrupt handler 310, the encoder 320, the scheduler 330, and/or the controller 340, etc., may be implemented as processing circuitry. Processing circuitry may include hardware or hardware circuit including logic circuits; a hardware/software combination such as a processor executing software and/or firmware; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc., but is not limited thereto.

The interrupt handler 310 may output at least one call signal in response to at least one interrupt signal. The call signal may be a signal to enable the encoder 320, but is not limited thereto. The call signal may be transmitted to the encoder 320, etc.

The encoder 320 may encode at least one instruction signal from characteristic data in response to the call signal. Then, the encoder 320 may transmit at least one instruction signal to the memory 102.

The scheduler 330 may monitor the memory 102 and perform at least one scheduling operation. The scheduling operation may be an operation for determining the order of outputting one or more instruction signals stored in the memory 102 according to and/or based on characteristics of a CXL processing device, etc., and outputting the one or more instruction signals according to and/or based on a determined and/or desired order. Instruction signals stored in the memory 102 may be output from the memory 102 to the compute logic 103 through at least one scheduling operation.

The controller 340 may control the memory 102. For example, the controller 340 may control the memory 102 to output vector data (e.g., the first vector data VD1 and the second vector data VD2, etc.) stored in the memory 102. For example, the controller 340 may control the memory 102 to provide the synchronized vector data SVD to a plurality of CXL processing devices, but the example embodiments are not limited thereto.

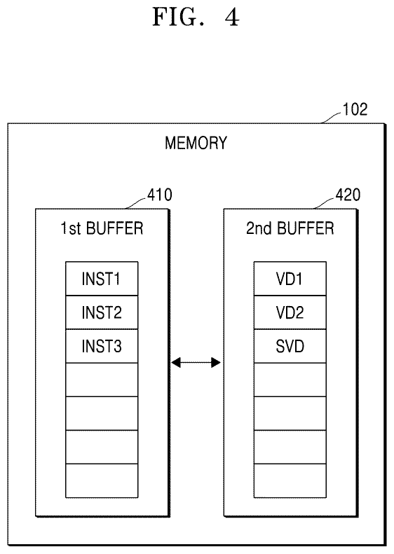

FIG. 4 is a block diagram showing a memory according to at least one example embodiment.

Referring to FIG. 4, the memory 102 may include a first buffer 410 and a second buffer 420, but the example embodiments are not limited thereto.

The first buffer 410 may temporarily store output vector data (e.g., the first vector data VD1 and the second vector data VD2, etc.) and the synchronized vector data SVD. The first buffer 410 may be referred to as a memory buffer.

The second buffer 420 may sequentially queue instruction signals. According to some example embodiments, the second buffer 420 may be implemented as a queue (and/or instruction queue) including a plurality of entries. However, the example embodiments of the inventive concepts are not limited thereto. According to some example embodiments, the scheduler 330 may monitor an instruction queue of the memory 102, etc.

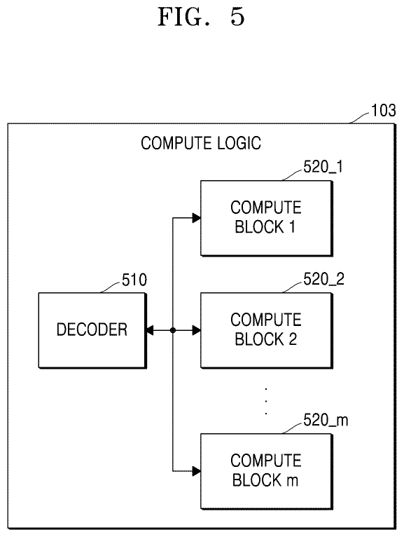

FIG. 5 is a block diagram showing a compute logic according to at least one example embodiment.

Referring to FIG. 5, the compute logic 103 may include a decoder 510 and first to m-th calculation blocks 520_1, 520_2, . . . , and 520_m, but is not limited thereto. M may be an integer equal to or greater than 2. According to some example embodiments, one or more of the decoder 510 and the first to m-th calculation blocks, etc., may be implemented as processing circuitry. Processing circuitry may include hardware or hardware circuit including logic circuits; a hardware/software combination such as a processor executing software and/or firmware; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc., but is not limited thereto.

The decoder 510 may decode at least one instruction signal to check at least one calculation operation.

At least one of the first to m-th calculation blocks 520_1, 520_2, . . . , and 520_m may perform an arithmetic operation according to and/or based on a decoded instruction signal. The first to m-th calculation blocks 520_1, 520_2, . . . , and 520_m may be implemented as hardware logic calculators to perform different calculation operations. At least one of the first to m-th calculation blocks 520_1, 520_2, . . . , and 520_m may transmit the synchronized vector data SVD to the memory 102.

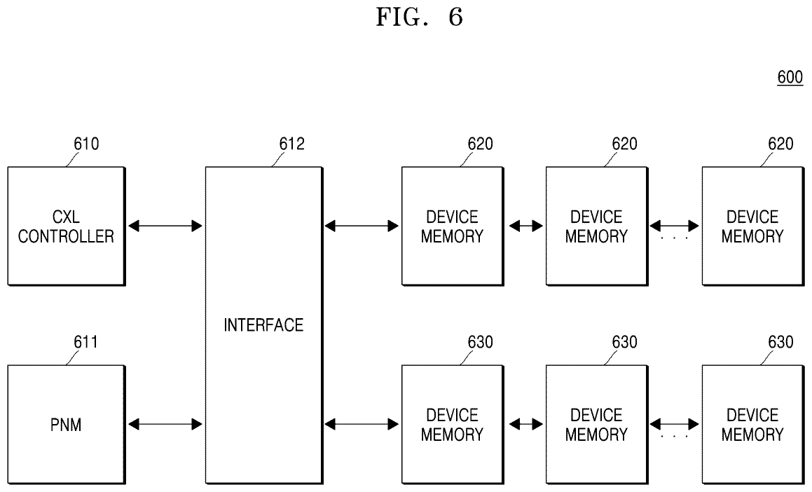

FIG. 6 is a block diagram showing a CXL processing device according to at least one example embodiment.

Referring to FIG. 6, a CXL processing device 600 according to some example embodiments may be implemented as a CXL-Processing-Near Memory (PNM), but is not limited thereto. A CXL-PNM may be used to process data, for example, in an AI model such as an LLM model, etc. The CXL processing device 600 may include a CXL controller 610, a PNM 611, an interface 612, and/or a plurality of device memories 620 and 630, etc., but is not limited thereto. According to some example embodiments, one or more of the CXL controller 610, the PNM 611, the interface 612, and/or the plurality of device memories 620 and 630, etc., may be implemented as processing circuitry. Processing circuitry may include hardware or hardware circuit including logic circuits; a hardware/software combination such as a processor executing software and/or firmware; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc., but is not limited thereto.

The CXL controller 610 (e.g., a memory controller, memory processing circuitry, etc.) may communicate with the plurality of device memories 620 and 630 through the interface 612. The CXL controller 610 may control each of the plurality of device memories 620 and 630 through the interface 612.

The PNM 611 may perform data processing operations. The PNM 611 may perform mathematical operations, such as matrix calculations and/or vector calculations, etc., but is not limited thereto. According to some example embodiments, the PNM 611 may include at least one register that stores information regarding partial matrices desired and/or needed for desired mathematical operations, such as a matrix multiplication calculation. The PNM 611 may transmit interrupt signals and/or packets to the CXL switch 100. According to some example embodiments, the CXL controller 610 and the PNM 611 may be integrated into one semiconductor chip, but the example embodiments of the inventive concepts are not limited thereto.

The plurality of device memories 620 and 630 may be implemented as, for example, volatile memories, but are not limited thereto, and for example, one or more of the device memories may be non-volatile memory devices.

Unlike the CXL processing device shown in FIG. 6, a CXL processing device according to other example embodiments may be implemented as a CXL-based GPU. Alternatively, a CXL processing device according to other example embodiments may also be implemented as an NPU designed based on FPGA, etc.

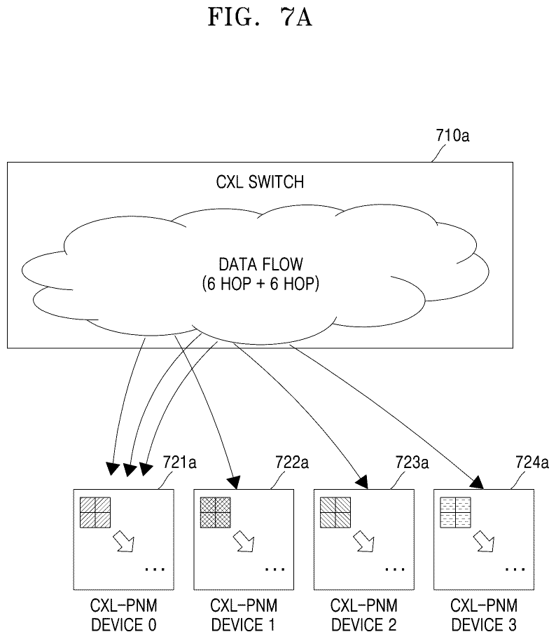

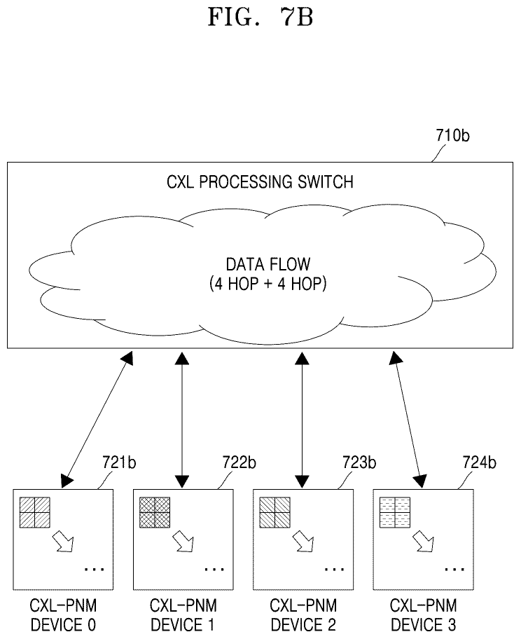

FIGS. 7A and 7B are diagrams for describing data flows according to a comparative example and at least one example embodiment. In detail, FIG. 7A is a diagram for describing data flow according to a comparative example, and FIG. 7B is a diagram for describing data flow according to at least one example embodiment.

Referring to FIG. 7A, a plurality of CXL-PNM devices 721a, 722a, 723a, and/or 724a, etc., may be configured as a memory pool by being connected to and/or connected below a CXL switch 710a, but the example embodiments are not limited thereto, and for example, there may be a greater or lesser number of CXL-PNM devices, etc. Therefore, the CXL-PNM devices 721a, 722a, 723a, and/or 724a, etc., may process vector data of an AI model, such as an LLM model, etc., in parallel, but are not limited thereto. A processing operation performed by each of the CXL-PNM devices 721a, 722a, 723a, and 724a may correspond to a portion of the overall processing operation of an AI model. Therefore, it is desired and/or necessary to synchronize vector data processed by the CXL-PNM devices 721a, 722a, 723a, and/or 724a, etc. To this end, some CXL-PNM devices 722a, 723a, and 724a (e.g., a subset of CXL-PNM devices, etc.) from among the plurality of CXL-PNM devices 721a, 722a, 723a, and 724a (e.g., the set of CXL-PNM devices, etc.) may each include vector data respectively processed in a packet and transmit each packet to a specific CXL-PNM device (e.g., a desired and/or central CXL-PNM device, such as CXL-PNM device 721a) through the CXL switch 710a. Then, the specific CXL-PNM device (e.g., the CXL-PNM device 721a) may synchronize the partially processed vector data (e.g., the vector data partially processed by the subset of CXL-PNM devices, etc.) included in the received packets and re-transmit packets containing synchronized vector data to the some CXL-PNM devices 722a, 723a, and 724a (e.g., the subset of CXL-PNM devices) through the CXL switch 710a. In the above-described processing process, at least one hop (e.g., network hop, etc.) may occur. The hop is a part of a path (e.g., a segment of a network path) between a source and a destination in a computer network. For example, a packet passes through a bridge, a router, and/or a gateway, etc., (e.g., network devices and/or network equipment, etc.) from a source to a destination, wherein a hop occurs each time a packet moves to a next network device. A hop may occur in the case (and/or a path) where a packet is moved from one CXL-PNM device to the CXL switch 710a. Also, in the case where a packet is moved from the CXL switch 710a to one CXL-PNM device, a hop may occur, and thus three hops may occur when respective packets are moved from the some CXL-PNM devices 722a, 723a, and 724a (e.g., the subset of CXL-PNM devices) to the CXL switch 710a. Also, when packets are moved from the CXL switch 710a to the specific CXL-PNM device (e.g., the CXL-PNM device 721a), three hops may occur. In other words, when packets are transmitted from some CXL-PNM devices 722a, 723a, and 724a (e.g., the subset of CXL-PNM devices) to the specific CXL-PNM device (e.g., the CXL-PNM device 721a) through the CXL switch 710a, six hops may occur. In this regard, even when packets containing synchronized vector data are transmitted from the specific CXL-PNM device (e.g., the CXL-PNM device 721a) to the some CXL-PNM devices 722a, 723a, and 724a (e.g., the subset of CXL-PNM devices), six hops may occur. According to the packet transmission process of FIG. 7A, when all packets are transmitted to one CXL-PNM device (e.g., CXL-PNM device 721a), a bottleneck may occur in a path including CXL-PNM devices and the CXL switch 710a.

Referring to FIG. 7B, CXL-PNM devices 721b, 722b, 723b, and 724b are configured as a memory pool below a CXL switch 710b, and thus vector data (e.g., embedding vector) of an AI model may be processed partially and/or may be processed in parallel. The CXL switch 710b according to at least one example embodiment of the inventive concepts may perform the synchronization processing performed by the CXL-PNM device 721a (e.g., the specific CXL-PNM device, the desired CXL-PNM device, the central CXL-PNM device, etc.) of FIG. 7A instead of the CXL-PNM devices 721b, 722b, 723b, and 724b (e.g., the subset of CXL-PNM devices). In other words, vector data processed by each of the CXL-PNM devices 721b, 722b, 723b, and 724b may be transmitted to the CXL switch 710b, the CXL switch 710b may generate synchronized vector data by performing a synchronization operation, and the CXL switch 710b may re-transmit the synchronized vector data to each of the CXL-PNM devices 721b, 722b, 723b, and 724b. In this case, when packets are transmitted from the CXL-PNM devices 721b, 722b, 723b, and 724b to the CXL switch 710b, four hops may occur. Also, when packets containing the synchronized vector data are transmitted from the CXL switch 710b to the CXL-PNM devices 721b, 722b, 723b, and 724b, four hops may occur. According to the packet transmission process of FIG. 7B, relatively fewer hops may occur in comparison to the comparative example of FIG. 7A, and thus the occurrence of a bottleneck may be reduced. Also, congestion that may occur in network paths between CXL-PNM devices and the CXL switch 710b may be reduced and/or prevented. Also, latency may be reduced in situations where large amounts of data are processed. Also, data may be processed quickly and efficiently in calculations and/or complex calculations for processing large amounts of data.

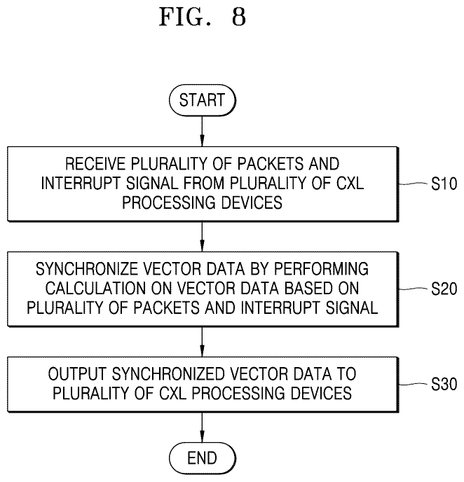

FIG. 8 is a flowchart of a method of operating a CXL switching device, according to at least one example embodiment.

Referring to FIG. 8, the method of operating an CXL switching device according to at least one example embodiment of the inventive concepts is a method of operating the CXL switch 100 of FIG. 1 and may include operation S10, operation S20, and/or operation S30, etc., but is not limited thereto.

In operation S10, a CXL switching device receives a plurality of packets (e.g., data packets, etc.) and at least one interrupt signal from a plurality of CXL processing devices. Each packet may include vector data and characteristic data. According to some example embodiments, operation S10 may include an operation of receiving a first packet and a first interrupt signal from a first CXL processing device and an operation of receiving a second packet and a second interrupt signal from a second CXL processing device, but is not limited thereto. For example, with reference to FIG. 2A, the CXL switch 100 receives the first packet PKT1 and the first interrupt signal IRT1 from the first CXL processing device 110_1. Then, the CXL switch 100 receives the second packet PKT2 and the second interrupt signal IRT2 from the second CXL processing device 110_2.

In operation S20, the CXL switching device synchronizes vector data by performing a calculation on the vector data based on the plurality of packets and the interrupt signal. For example, with reference to FIGS. 2A and 2B, the CXL switch 100 generates an instruction signal in response to the received interrupt signal from the CXL processing device(s) and synchronizes vector data of the respective packets by calculating the vector data based on the received instruction signal.

In operation S30, the CXL switching device outputs synchronized vector data to the plurality of CXL processing devices. For example, with reference to FIG. 2C, the compute logic 103 stores synchronized vector data SVD in the memory 102. The control logic 101 provides the memory control signal MCNT to the memory 102. The memory 102 outputs the synchronized vector data SVD in response to the memory control signal MCNT. The synchronized vector data SVD is transmitted in parallel to the first CXL processing device 110_1 and the second CXL processing device 110_2, but is not limited thereto, and for example, may transmit the synchronized vector data serially.

According to some example embodiments of the inventive concepts, the method of operating a CXL switching device may further include an operation of outputting a synchronization completion signal to the plurality of CXL processing devices. According to some example embodiments, the operation of outputting a synchronization completion signal to the plurality of CXL processing devices may be performed before operation S30, but is not limited thereto.

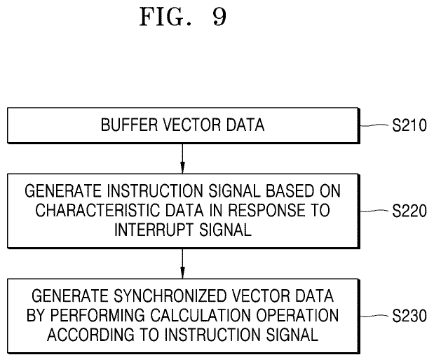

FIG. 9 is a flowchart for describing at least one example embodiment of operation S20 of FIG. 8.

Referring to FIG. 9, operation S20 may include operation S210, operation S220, and/or operation S230, but is not limited thereto.

In operation S210, the CXL switching device buffers vector data. For example, with reference to FIGS. 2A and 4, the first vector data VD1 corresponding to the first output vector data 241 is stored in the second buffer 420, and the second vector data VD2 corresponding to the second output vector data 242 is stored in the second buffer 420, but the example embodiments are not limited thereto.

In operation S220, the CXL switching device generates at least one instruction signal based on the characteristic data in response to the interrupt signal. For example, with reference to FIGS. 2A and 2B, the control logic 101 generates a first instruction signal INST1 based on the first characteristic data of the first packet PKT1 and the first instruction signal INST1 is stored in memory 102, but is not limited thereto.

In operation S230, the CXL switching device generates synchronized vector data by performing a calculation operation according to at least one instruction signal. For example, with reference to FIGS. 2A and 2B, the control logic 101 outputs the scheduling control signal SCNT to the memory 102. The memory 102 outputs a first instruction signal INST1 in response to the scheduling control signal SCNT. The control logic 101 controls the memory 102 to output the first vector data VD1 and the second vector data VD2 stored in the memory 102. The compute logic 103 receives the first instruction signal INST1, the first vector data VD1, and the second vector data VD2 from the memory 102. The compute logic 103 checks the calculation operation 250 by decoding the first instruction signal INST1. The compute logic 103 generates synchronized vector data SVD by calculating (e.g., summing) the first output vector data 241 and the second output vector data 242, but is not limited thereto.

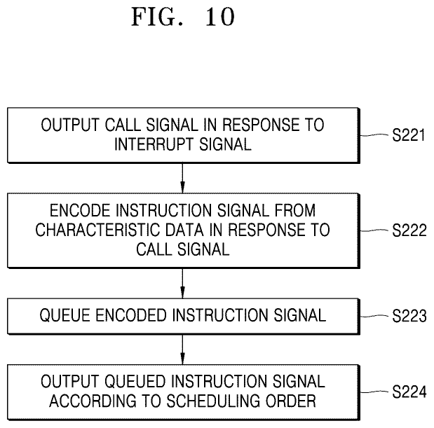

FIG. 10 is a flowchart of operation S220 of FIG. 9 according to at least one example embodiment.

Referring to FIG. 10, operation S220 may include operation S221, operation S222, operation S223, and/or operation S224, but the example embodiments are not limited thereto.

In operation S221, the CXL switching device outputs at least one call signal in response to at least one interrupt signal. Operation S221 may be performed by the interrupt handler 310 of FIG. 3, but is not limited thereto.

In operation S222, the CXL switching device encodes at least one instruction signal from the characteristic data in response to the at least one call signal. Operation S222 may be performed by the encoder 320 of FIG. 3, but is not limited thereto.

In operation S223, the CXL switching device queues at least one encoded instruction signal. Operation S223 may be performed by the encoder 320 of FIG. 3, but is not limited thereto.

In operation S224, the CXL switching device outputs a queued instruction signal according to and/or based on a scheduling order. For example, the scheduling order may include scheduling information related to the processing of the one or more instruction signals and/or data packets containing vector data received from the plurality of CXL processing devices, etc., but is not limited thereto. Operation S224 may be performed by the scheduler 330 of FIG. 3, but is not limited thereto.

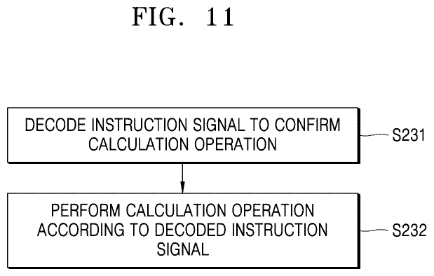

FIG. 11 is a flowchart for describing operation S230 of FIG. 9 according to at least one example embodiment.

Referring to FIG. 11, operation S230 includes operation S231 and operation S232, but is not limited thereto.

In operation S231, the CXL switching device decodes at least one instruction signal to confirm and/or determine at least one calculation operation. For example, the CXL switching device may determine and/or confirm the type of calculation operation to perform based on the decoded at least one instruction signal, etc. Operation S231 may be performed by the decoder 510 of FIG. 5, but the example embodiments are not limited thereto.

In operation S232, the CXL switching device performs an operation according to and/or based on a decoded instruction signal. Operation S232 may be performed by at least one of the first to m-th calculation blocks 520_1, 520_2, . . . , and 520_m of FIG. 5.

While various example embodiments of the inventive concepts have been particularly shown and described, it will be understood that various changes in form and details may be made therein without departing from the spirit and scope of the following claims.

What is claimed is:

1. A compute express link (CXL)-based system comprising:
a plurality of CXL processing devices configured to,
perform matrix multiplication calculation based on input vector data and a partial matrix, and
output at least one interrupt signal and at least one packet based on results of the matrix multiplication calculation, the at least one packet including output vector data and characteristic data associated with the output vector data; and
a CXL switching device configured to,
synchronize the output vector data, the synchronizing including performing a calculation operation on the output vector data based on the interrupt signal and the packet, and
provide the synchronized vector data to the plurality of CXL processing devices.

2. The system of claim 1, wherein the CXL switching device comprises:
memory configured to store the output vector data; and
processing circuitry configured to,
store at least one instruction signal in the memory based on the characteristic data in response to the at least one interrupt signal,
perform the calculation operation based on the stored at least one instruction signal,
generate the synchronized vector data based on results of the calculation operation, and
store the synchronized vector data in the memory.

3. The system of claim 2, wherein the processing circuitry is further configured to:
output at least one call signal in response to the at least one interrupt signal;
encode the at least one instruction signal from the characteristic data and transmit the at least one instruction signal to the memory, in response to the at least one call signal;
perform a scheduling operation to output a stored instruction signal from the memory to the processing circuitry; and
provide the synchronized vector data stored in the memory to the plurality of CXL processing devices.

4. The system of claim 2, wherein the processing circuitry is further configured to:
decode the at least one instruction signal to determine a type of the calculation operation;
perform the calculation operation based on the decoded at least one instruction signal and the determined calculation operation type; and
transmit the synchronized vector data to the memory.

5. The system of claim 2, wherein the memory is further configured to:
temporarily store the output vector data and the synchronized vector data; and
sequentially queue the at least one instruction signal.

6. The system of claim 1, wherein the plurality of CXL processing devices comprise:
a first CXL processing device configured to perform a first matrix multiplication calculation between a first partial matrix of a weight matrix of an artificial intelligence (AI) model and first input vector data; and
a second CXL processing device configured to perform a second matrix multiplication calculation of the first input vector data with a second partial matrix that is different from the first partial matrix.

7. The system of claim 1, wherein the plurality of CXL processing devices comprise:
a first CXL processing device configured to perform a first matrix multiplication calculation based on a first partial matrix and first input vector data; and
a second CXL processing device configured to perform a second matrix multiplication calculation based on the first partial matrix and second input vector data.

8. The system of claim 1, wherein each of the plurality of CXL processing devices comprises:
a plurality of device memories; and
memory processing circuitry configured to control the plurality of device memories, and
perform the matrix multiplication calculation and transmit the at least one interrupt signal and the at least one packet to the CXL switching device.

9. A method of operating a compute express link (CXL) switching device, the method comprising:
receiving a plurality of packets and at least one interrupt signal from a plurality of CXL processing devices, wherein each of the plurality of packets includes vector data and characteristic data associated with the vector data;
synchronizing the vector data, the synchronizing including performing a calculation operation on the vector data based on the plurality of packets and the interrupt signal; and
outputting the synchronized vector data to the plurality of CXL processing devices.

10. The method of claim 9, wherein the receiving of the plurality of packets and the at least one interrupt signal comprises:
receiving a first packet and a first interrupt signal from a first CXL processing device; and
receiving a second packet and a second interrupt signal from a second CXL processing device.

11. The method of claim 9, wherein the synchronizing of the vector data comprises:
buffering the vector data;
generating at least one instruction signal based on the characteristic data in response to the at least one interrupt signal; and
generating the synchronized vector data by performing the calculation operation based on the at least one instruction signal.

12. The method of claim 11, wherein the generating of the at least one instruction signal comprises:
outputting at least one call signal in response to the at least one interrupt signal;
encoding the at least one instruction signal from the characteristic data, in response to the at least one call signal;
queuing at least one encoded instruction signal; and
outputting at least one queued instruction signal based on a scheduling order.

13. The method of claim 11, wherein the generating of the synchronized vector data comprises:
decoding the at least one instruction signal to determine a type of operation of the calculation operation; and
performing the calculation operation based on the at least one decoded instruction signal and the determined type of calculation operation.

14. The method of claim 9, further comprising:
outputting at least one synchronization completion signal to the plurality of CXL processing devices.

15. A network device comprising:
memory configured to store vector data of a plurality of packets received from a plurality of processing devices; and
processing circuitry configured to,
store at least one instruction signal in the memory based on characteristic data of the plurality of packets in response to a plurality of interrupt signals received from the plurality of processing devices,
determine a calculation operation type based on at least one instruction signal stored in the memory,
synchronize vector data stored in the memory, the synchronizing including performing the calculation operation on the vector data based on the determined calculation operation type, and
output the synchronized vector data.

16. The network device of claim 15, wherein the memory is further configured to:
store the vector data and the synchronized vector data; and
queue the at least one instruction signal.

17. The network device of claim 15, wherein the processing circuitry is further configured to:
output at least one call signal in response to the plurality of interrupt signals;
encode the at least one instruction signal from the characteristic data, in response to the at least one call signal;
perform a scheduling operation to output the stored at least one instruction signal based on the characteristic data; and
provide the synchronized vector data from the memory to the plurality of processing devices.

18. The network device of claim 15, wherein the processing circuitry is further configured to:
decode the at least one instruction signal to determine an operation type of the calculation operation; and
perform the calculation operation based on the decoded at least one instruction signal and the determined operation type.

19. The network device of claim 15, wherein the processing circuitry is further configured to:
sequentially output at least one synchronization completion signal and the synchronized vector data.

20. The network device of claim 15, wherein the network device comprises a CXL switch.
